(19) United States
(12) Patent Application Publication
(10) Pub. No.: US 2026/0119470 A1
(43) Pub. Date: Apr. 30, 2026

(54) ARTIFICIALLY INTELLIGENT CONTENT SURFACING OF RELEVANT CONTENT FROM HETEROGENEOUS CONTENT SOURCES

(71) Applicant: Delve Deep Learning Inc., Washington, DC (US)

(72) Inventors: Jeffrey Edward Berkowitz, Washington, DC (US); Kyle Joseph Huwa, Washington, DC (US)

(73) Assignee: Delve Deep Learning Inc., Washington, DC (US)

(21) Appl. No.: 18/927,439

(22) Filed: Oct. 25, 2024

(51) Int. Cl. G06F 16/22; G06F 16/2457; G06N 3/0475; G06N 3/08

(52) U.S. Cl. CPC G06F 16/2237; G06F 16/24578; G06N 3/0475; G06N 3/08

(57) ABSTRACT

Artificially intelligent content surfacing includes ingesting into a data structure tokens representative of textual phrases describing relevant topical content and generating a primary dense vector representation of the data structure. The surfacing further includes establishing connections to different content sources through different APIs and retrieving textual content from each content source through the different connections. The surfacing yet further includes generating a secondary dense vector representation for the retrieved content and comparing each secondary dense vector representation to the primary dense vector representation to detect a threshold similarity. The surface yet further includes assembling a prompt to a large language model (LLM) with the data structure and the textual content corresponding to threshold similar secondary dense vector representations and submitting the prompt to the LLM. Finally, the surfacing includes retrieving from the LLM a set of references to the retrieved textual content and transmitting the set to the end user.

### BACKGROUND OF THE INVENTION

### Field of the Invention

The present invention relates to the technical field of data subscription fulfillment and more particularly to content surfacing of content aggregated from heterogeneous content sources relevant to a subscriber profile.

### Description of the Related Art

Content aggregation refers to the gathering and organizing of related information from various content sources and the presentation of the related information in a single document for users to access and reference. The goal of content aggregation is to ensure that only essential information is collected that focuses upon a single topic of interest of the end user. Content aggregation traditionally has been performed by an individual or with the assistance of tools including natural language processing (NLP). Content aggregation can be performed directly through a user interface to an aggregation platform, such as a Web page, or programmatically through an application programming interface (API).

The most basic form of content aggregation is the manual periodic newsletter in which a publisher aggregates summarizations from different content sources into a single digital newsletter. So much, though, requires the subjective judgment of an editor to curate the content to be summarized in the newsletter and, inherently, the bias of the editor along with the level of expertise of the editor can influence the nature of the content summarized and the content excluded from inclusion in the digital newsletter. In order to mitigate against such bias, more recent aggregation endeavors include subscription feeds such as the venerable really simple syndication (RSS) feed. RSS is a web feed that allows users and applications to access updates to websites in a standardized, computer-readable format. RSS, however, still requires the subscriber to specifically subscribe to different content sources.

The universe of relevant content to the interests of a subscriber, however, is vast and expecting a subscriber to know a priori the network location of all pertinent content so as to surface to the subscriber the most pertinent content is not realistic. Indeed, the mere keyword searching of a repository of content will result in most cases with an overbroad result set owing to the imprecise selection of keywords. Alternatively, the intentional narrowing of a keyword search to limit the size of a result set can result in the unintentional omission of relevant content.

### BRIEF SUMMARY OF THE INVENTION

Embodiments of the present invention address technical deficiencies of the art in respect to content surfacing. To that end, embodiments of the present invention provide for a novel and non-obvious method for artificially intelligent content surfacing of content from heterogeneous content sources. Embodiments of the present invention also provide for a novel and non-obvious computing device adapted to perform artificially intelligent content surfacing of content from heterogeneous content sources. Finally, embodiments of the present invention provide for a novel and non-obvious data processing system incorporating the foregoing device in order to perform the foregoing method.

In one embodiment of the invention, a method for artificially intelligent content surfacing of content from heterogeneous content sources includes the ingestion into a data structure of different tokens representative of textual phrases describing topical content specified as relevant by an end user. The method additionally includes the generation of a primary dense vector representation of the data structure. The method further includes the establishment of different communicative connections to respectively different heterogeneous content sources through respectively different application programming interfaces (APIs) and the retrieval of content including textual content, audible content, visual content and audio visual content from each of the content sources through the different communicative connections.

The method yet further includes the generation of a secondary dense vector representations for portions of the retrieved textual content and the comparison of each of the secondary dense vector representations to the primary dense vector representation in order to detect a threshold similarity. The method even yet further includes the assembly of a prompt to a large language model (LLM) with the data structure and portions of the textual content corresponding to ones of the secondary dense vector representations which are determined to be threshold similar, and the submission of the prompt to the LLM. Finally, the method includes the retrieval from the LLM in response to the prompt of a set of references to the retrieved textual content and the transmission of the set of references to the end user.

In one aspect of the embodiment, the method additionally includes an assignment of a relevance score to each of the references in the set and the low rank adaptation fine tuning of the LLM according to the assigned relevance score of each of the references in the set. The assignment of the relevance score can be at the direction of the LLM or the end user, or at the direction of the LLM as modified by the end user. Alternatively, the method additionally includes an assignment of a relevance score to different tokens in the data structure and the low rank adaptation fine tuning of the prompt to the LLM according to the assigned relevance score of the different tokens.

In another aspect of the embodiment, the method additionally includes the retrieval from the LLM in response to the prompt and in addition to the set of references, justification text which includes explanatory text which justifies the selection of each of the references included in the set, and the inclusion of portions of the justification text in the transmission in connection with corresponding ones of the references in the set. In yet another aspect of the embodiment, the method additionally includes the inclusion of different computed values for the similarity in the transmission in connection with corresponding ones of the references in the set.

In another embodiment of the invention, a data processing system is adapted for artificially intelligent content surfacing of content from heterogeneous content sources. The system includes a host computing platform that has one or more computers, each with memory and one or processing units including one or more processing cores. The system also includes a network interface coupled to the memory and the one or more processing units. The system yet further includes different communicative connections established in the network interface to respectively different heterogeneous content sources through respectively different APIs. Finally, the system includes a content surfacing module including computer program instructions which are executable in the memory of the host computing platform by the processing units of the host computing platform.

The program instructions are enabled while executing in the memory of at least one of the processing units of the host computing platform to perform the ingestion into a data structure of different tokens representative of textual phrases describing topical content specified as relevant by an end user, and the generation of a primary dense vector representation of the data structure. The program instructions additionally are enabled to retrieve textual content from each of the content sources through the different communicative connections and to generate secondary dense vector representations for portions of the retrieved textual content.

With the secondary dense vector representations for the portions of the retrieved textual content, the program instructions compare each of the secondary dense vector representations to the primary dense vector representation in order to detect a threshold similarity. The program instructions further are enabled to assemble a prompt to an LLM with the data structure and portions of the textual content corresponding to threshold similar ones of the secondary dense vector representations and to submit the prompt to the LLM. Finally, the program instructions are enabled to retrieve from the LLM in response to the prompt a set of references to the retrieved textual content and to transmit the set of references to the end user.

In this way, the technical deficiencies of the traditional content subscription feed can be overcome, in which the subscriber is expected to know a priori the network location of all pertinent content sources so as to surface to the subscriber the most pertinent content, or in which the subscriber is expected to precisely select keywords for searching with the risk of an overbroad or overly narrow result set, in both cases, without affording the subscriber the opportunity to feedback an assessed relevancy of the content in the result set. Specifically, those deficiencies are overcome owing to the submission of a prompt to the LLM for the surfacing of content references, with a data structure of tokens representative of textual phrases describing topical content specified as relevant by an end user, along with only those portions of textual content which had been retrieved from heterogeneous content sources and which correspond to a threshold similar match between a primary dense vector representation of the data structure and secondary dense vector representations of the retrieved content.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration reflecting different aspects of a process of artificially intelligent content surfacing of content from heterogeneous content sources;

FIG. 2 is a block diagram depicting a data processing system adapted to perform one of the aspects of the process of FIG. 1; and,

FIG. 3 is a flow chart illustrating one of the aspects of the process of FIG. 1.

### DETAILED DESCRIPTION OF THE INVENTION

Embodiments of the invention provide for artificially intelligent content surfacing of content from heterogeneous content sources. In accordance with an embodiment of the invention, the artificially intelligent surfacing of content from heterogeneous content sources begins with the determination and tokenization of a user profile into a data structure, which reflects the needs and requirements of the user in respect to desired content to be surfaced from the heterogeneous content sources, and the generation of a primary dense vector representation of the data structure holding the tokenized profile. Various communicative couplings are established with different heterogeneous content sources and portions of textual content is retrieved from each of the content sources. In this regard, the heterogeneous content sources can range from API accessible repositories of content in remote data stores, to published documentation accessible by respectively different network addressing.

For each portion of the textual content, a secondary dense vector representation is generated and stored for comparison with the primary dense vector representation so that threshold similar ones of the secondary vector representations are determined to be preliminarily relevant to the user profile. As such, the portions of the textual content associated with the threshold similar ones of the secondary vector representations are submitted in a prompt to an LLM along with the data structure in order to retrieve a set of content references for surfacing to the end user as particularly relevant to the user profile. Optionally, users can assign their own relevance scores to the tokens and the portions of the textual content in order to tune the LLM in a follow-on prompt to the LLM, for example using low rank adaptation fine tuning.

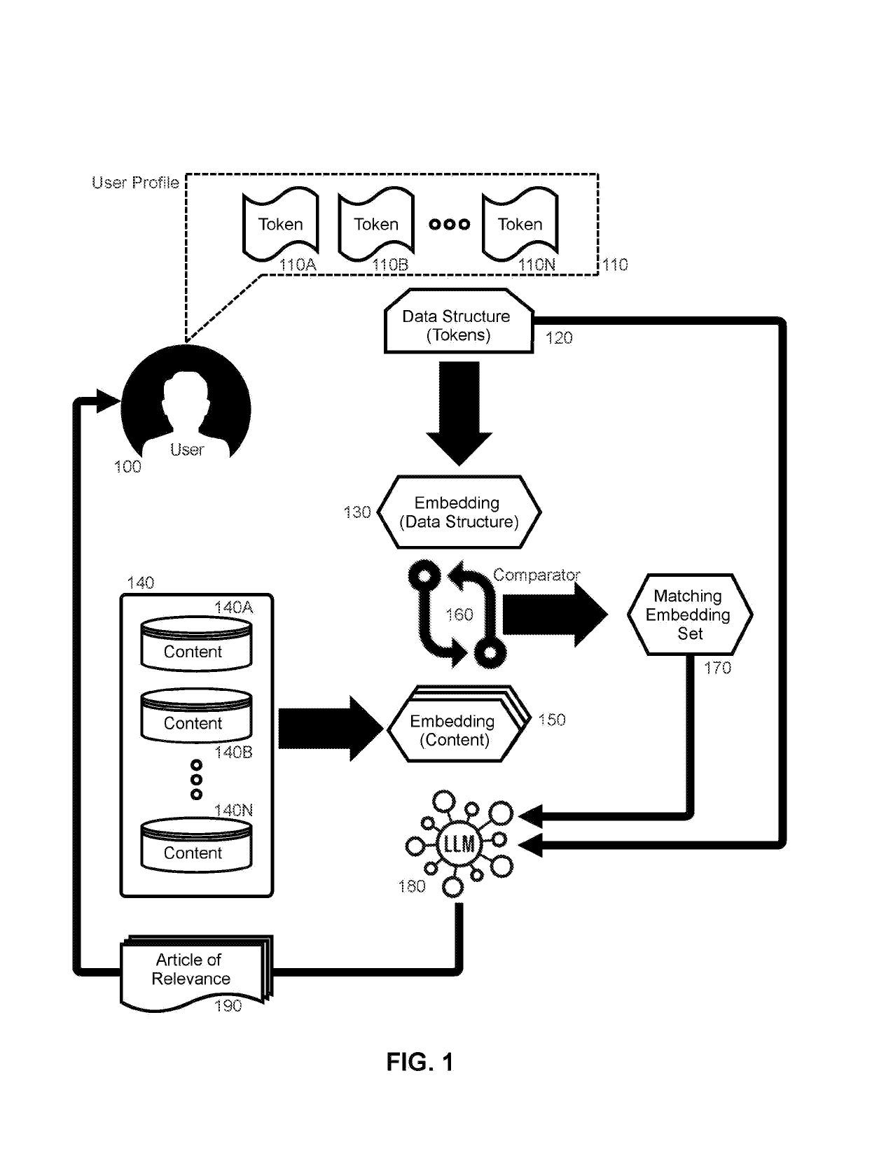

In illustration of one aspect of the embodiment, FIG. 1 pictorially shows a process of artificially intelligent content surfacing of content from heterogeneous content sources. As shown in FIG. 1, a user profile 110 can be established for an end user 100. The profile includes different tokens 110A, 110B, 110N which reflect terms or phrases representative of the topical interests of the end user 100 and/or the demographic, political, economic, geographic and industrial characteristics of the end user 100 or the business goals or concerns of the end user 100. The tokens 110A, 110B, 110N are encapsulated within a data structure 120 manipulable by computer programmatic logic within a computer data processing system and, within the computer data processing system, a primary dense vector representation 130 is generated reflecting the conceptual meaning of the data structure 120 through the programmatic creation of word embeddings, for instance, through the execution of a sentence transformer implementing a support vector machine (SVM) algorithm reliant upon a trained classifier model with a topic classification for the classifier model and pre-annotation model text. As well, the conceptual meaning of the data structure 120 can be determined by directing an LLM 180 through an interface to the LLM 180 to craft a sample article reflective of the data structure 120 and to create a primary dense vector representation 130 of the sample article.

Concurrently, a set of secondary dense vector representations 150 are generated from content 140 sourced from remotely accessible, heterogeneous content sources 140A, 140B, 140N. A comparator 160 then compares the primary dense vector representation 130 to each of the secondary dense vector representations 150 in order to identify threshold similar ones of the secondary dense vector representations 150 to the primary dense vector representation 130. An example of threshold similar includes a cosine similar comparative determination. Portions 170 of the content 140 associated with threshold similar ones of the secondary dense vector representations 150 are then submitted to an LLM 180 through an interface to the LLM 180 along with the data structure 120. The LLM 180 in response returns articles of relevance 190 to the user profile 110 for transmission to the end user 100 as artificially intelligent surfaced content.

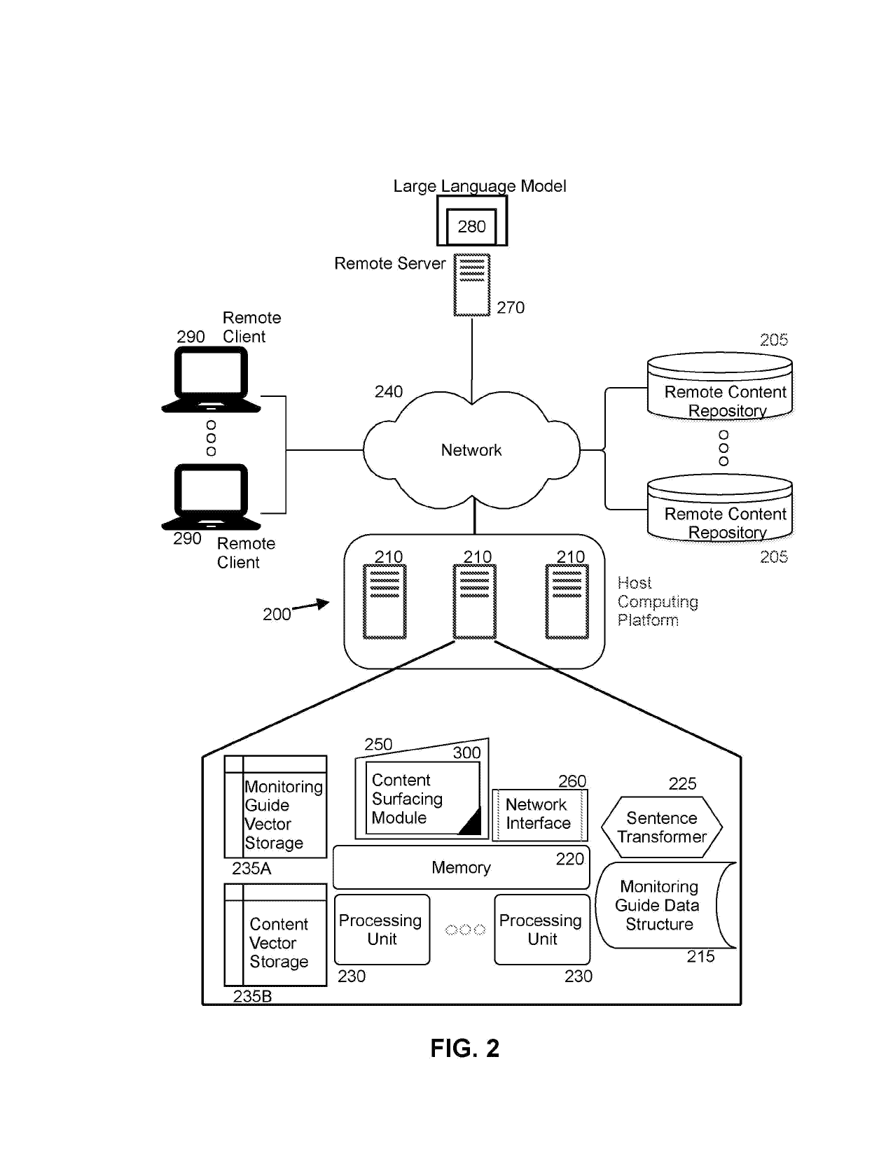

Aspects of the process described in connection with FIG. 1 can be implemented within a data processing system. In further illustration, FIG. 2 schematically shows a data processing system adapted to perform artificially intelligent content surfacing of content from heterogeneous content sources. In the data processing system illustrated in FIG. 1, a host computing platform 200 is provided. The host computing platform 200 includes one or more computers 210, each with memory 220 and one or more processing units 230. The computers 210 of the host computing platform (only the structural detail of a single computer shown for the purpose of illustrative simplicity) can be co-located within one another and in communication with one another over a local area network, or over a data communications bus, or the computers can be remotely disposed from one another and in communication with one another through network interface 260 over a data communications network 240.

The host computing platform 200 is communicatively coupled to different content repositories 205 over the data communications network 240, the content repositories 205 ranging from a simple data store to which communicative connectivity can be established, to complex database management systems accessible only through a corresponding API. As well, the host computing platform 200 is communicatively coupled to a remote server 270 over the data communications network 240 providing a prompt/response user interface to one or more LLMs 280. Finally, the host computing platform 200 is adapted for communicative coupling to different remote clients 290 of respectively different end users over the data communications network 240.

Notably, a computing device 250 including a non-transitory computer readable storage medium can be included with the data processing system 200 and accessed by the processing units 230 of one or more of the computers 210. The computing device stores 250 thereon or retains therein a program module 300 that includes computer program instructions. The program instructions, when executed by one or more of the processing units 230, perform a programmatically executable process for artificially intelligent content surfacing of content from heterogeneous content sources.

Specifically, the program instructions during execution ingest a textual specification of a user profile specified by an end user accessing the host computing platform 200 from a corresponding one of the remote clients 290. The program instructions tokenize portions of the textual specification into a data structure 215 and invoke sentence transformer 225 to generate a primary dense vector representation reflecting the conceptual meaning of the data structure 215 for insertion into a table of primary vectors 235A in the memory 220. In this regard, the table of primary vectors 235A can store different primary dense vector representations for correspondingly different end users accessing the host computing platform from correspondingly different ones of the remote clients 290 from over the data communications network 240.

The program instructions, concurrently, capture content portions from the different remote content repositories 205 and for each content portion, the program instructions direct the sentence transformer 225 to produce a secondary dense vector representation of the content portion for storage in content vector storage 235B. Thereafter, the program instructions, for a specific end user, compare the primary dense vector representation of the data structure 215 for the specific end user stored in the table of primary vectors 235A to the secondary dense vector representations in the content vector storage 235B. The program instructions then retrieve ones of the content portions corresponding to threshold similar ones of the secondary dense vectors and submit in a prompt the retrieved ones of the content portions to the LLM 280 along with the data structure 215.

Thereafter, the LLM 280 returns a result set of articles of relevance to the program instructions from over the data communications network 240 and the program instructions return the result set of articles to the specific end user at a corresponding one of the remote clients 290 through network interface 260. As it will be understood, the LLM 280 can return in addition to the result set of articles of relevance, justification text explaining why the LLM 280 selected the articles in the result set, along with a relevance score. Consequently the program instructions can return the justification text and the relevance score to the specific end user.

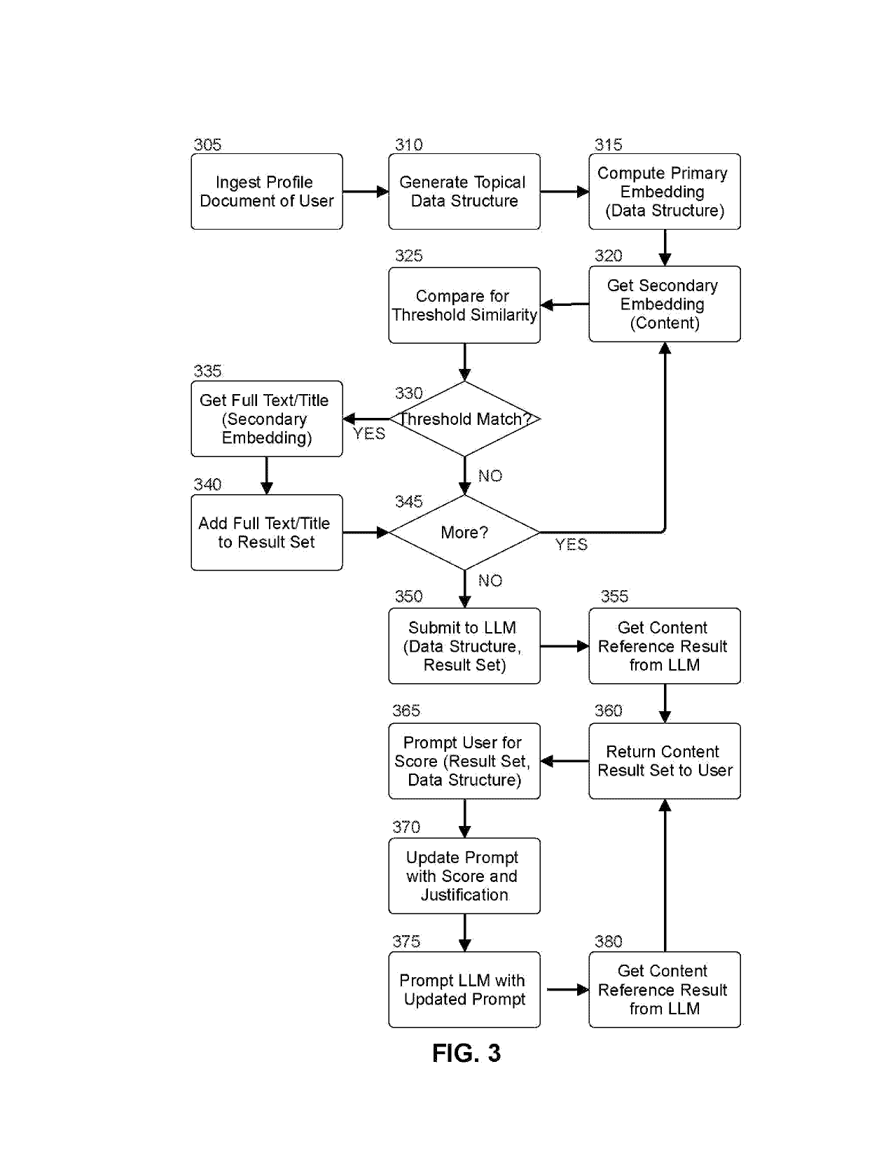

In further illustration of an exemplary operation of the module, FIG. 3 is a flow chart illustrating one of the aspects of the process of FIG. 1. Beginning in block 305, a user profile document is ingested for an end user and in block 310 the content of the document provides a basis for the generation of a data structure encapsulating different tokens pertinent to the topical profile of the end user. In block 315, a primary embedding (dense vector representation) is computed for the data structure. Thereafter, in block 320 a first one of a set of secondary embeddings (dense vector representation) for stored content is retrieved and compared in block 325 to the primary embedding in order to determine threshold similarity, e.g. similarity of both vectors within a pre-determined threshold value.

On condition in decision block 330 that a threshold similarity match exists for the vectors, in block 335 a portion of the content (including potentially the entirety of the content), as well as a title of the content, associated with the secondary embedding is retrieved and added to a result set in block 340. In decision block 345, if additional secondary embeddings remain to be processed, in block 320 a next one of the set of secondary embeddings is retrieved for comparison in block 325 and the process repeats in decision block 330. In decision block 345 when no further secondary embeddings remain to be compared to the primary embedding, in block 350 the result set is incorporated into a prompt along with the data structure, or tokens within the data structure, for transmission to an LLM. In block 355, a result set is received from the LLM in response to the prompt including both a relevancy score and justification text. Thereafter, in block 360 the result set is formatted for appearance and transmitted to a computing client of the end user.

In block 365, different score values of the different entries of the result set are retrieved and displayed in terms of relevance. As such, the different score values are applied to corresponding ones of the different tokens in the data structure. As such, in block 370, a tuning prompt is created including the score values for use in re-submitting the prompt in the future to the LLM. In block 375, the updated prompt is then provided to the LLM and in block 380, an updated result set is received from the LLM. Once again, in block 360, the updated result set is formatted for appearance and transmitted to the computing client of the end user. The process repeats until a decision is elected to terminate the process.

Of import, the foregoing flowchart and block diagram referred to herein illustrate the architecture, functionality, and operation of possible implementations of systems, methods, and computing devices according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

More specifically, the present invention may be embodied as a programmatically executable process. As well, the present invention may be embodied within a computing device upon which programmatic instructions are stored and from which the programmatic instructions are enabled to be loaded into memory of a data processing system and executed therefrom in order to perform the foregoing programmatically executable process. Even further, the present invention may be embodied within a data processing system adapted to load the programmatic instructions from a computing device and to then execute the programmatic instructions in order to perform the foregoing programmatically executable process.

To that end, the computing device is a non-transitory computer readable storage medium or media retaining therein or storing thereon computer readable program instructions. These instructions, when executed from memory by one or more processing units of a data processing system, cause the processing units to perform different programmatic processes exemplary of different aspects of the programmatically executable process. In this regard, the processing units each include an instruction execution device such as a central processing unit or "CPU" of a computer. One or more computers may be included within the data processing system. Of note, while the CPU can be a single core CPU, it will be understood that multiple CPU cores can operate within the CPU and in either instance, the instructions are directly loaded from memory into one or more of the cores of one or more of the CPUs for execution.

Aside from the direct loading of the instructions from memory for execution by one or more cores of a CPU or multiple CPUs, the computer readable program instructions described herein alternatively can be retrieved from over a computer communications network into the memory of a computer of the data processing system for execution therein. As well, only a portion of the program instructions may be retrieved into the memory from over the computer communications network, while other portions may be loaded from persistent storage of the computer. Even further, only a portion of the program instructions may execute by one or more processing cores of one or more CPUs of one of the computers of the data processing system, while other portions may cooperatively execute within a different computer of the data processing system that is either co-located with the computer or positioned remotely from the computer over the computer communications network with results of the computing by both computers shared therebetween.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for artificially intelligent content surfacing of content from heterogeneous content sources, the method comprising:
ingesting into a data structure, different tokens representative of textual phrases describing topical content specified as relevant by an end user;
generating a primary dense vector representation of the data structure;
establishing different communicative connections to respectively different heterogeneous content sources through respectively different application programming interfaces (APIs) and retrieving textual content from each of the content sources through the different communicative connections;
generating secondary dense vector representations for portions of the retrieved textual content and comparing each of the secondary dense vector representations to the primary dense vector representation in order to detect a threshold similarity;
assembling a prompt to a large language model (LLM) with the data structure and portions of the textual content corresponding to ones of the secondary dense vector representations which are determined to be threshold similar, and submitting the prompt to the LLM; and,
retrieving from the LLM in response to the prompt a set of references to the retrieved textual content and transmitting the set of references to the end user.

2. The method of claim 1, further comprising:
assigning a relevancy score to each of the references in the set; and,
low rank adaptation fine tuning the LLM according to the assigned relevancy score of each of the references in the set.

3. The method of claim 1, further comprising:
assigning a score to different tokens in the data structure; and,
low rank adaptation fine tuning the LLM according to the assigned score of the different tokens.

4. The method of claim 1, further comprising:
retrieving from the LLM in response to the prompt in addition to the set of references, justification text justifying a selection of each of the references included in the set; and,
including portions of the justification text in the transmission in connection with corresponding ones of the references in the set.

5. The method of claim 1, further comprising:
including different values for the similarity in the transmission in connection with corresponding ones of the references in the set.

6. A data processing system adapted for artificially intelligent content surfacing of content from heterogeneous content sources, the system comprising:
a host computing platform comprising one or more computers, each with memory and one or more processing units including one or more processing cores;
a network interface coupled to the memory and the one or more processing units;
different communicative connections established in the network interface to respectively different heterogeneous content sources through respectively different application programming interfaces (APIs); and,
a content surfacing module comprising computer program instructions enabled while executing in the memory of at least one of the processing units of the host computing platform to perform:
ingesting into a data structure, different tokens representative of textual phrases describing topical content specified as relevant by an end user;
generating a primary dense vector representation of the data structure;
retrieving textual content from each of the content sources through the different communicative connections;
generating secondary dense vector representations for portions of the retrieved textual content and comparing each of the secondary dense vector representations to the primary dense vector representation in order to detect a threshold similarity;
assembling a prompt to a large language model (LLM) with the data structure and portions of the textual content corresponding to ones of the secondary dense vector representations which are determined to be threshold similar, and submitting the prompt to the LLM; and,
retrieving from the LLM in response to the prompt a set of references to the retrieved textual content and transmitting the set of references to the end user.

7. The system of claim 6, wherein the program instructions are further enabled to perform:
assigning a relevancy score to each of the references in the set; and,
low rank adaptation fine tuning the LLM according to the assigned relevancy score of each of the references in the set.

8. The system of claim 6, wherein the program instructions are further enabled to perform:
assigning a relevancy score to different tokens in the data structure; and,
low rank adaptation fine tuning the LLM according to the assigned relevancy score of the different tokens.

9. The system of claim 6, wherein the program instructions are further enabled to perform:
retrieving from the LLM in response to the prompt in addition to the set of references, justification text justifying a selection of each of the references included in the set; and,
including portions of the justification text in the transmission in connection with corresponding ones of the references in the set.

10. The system of claim 6, wherein the program instructions are further enabled to perform:
including different values for the similarity in the transmission in connection with corresponding ones of the references in the set.

11. A computing device comprising a non-transitory computer readable storage medium having program instructions stored therein, the instructions being executable by at least one processing core of a processing unit to cause the processing unit to perform an artificially intelligent content surfacing of content from heterogeneous content sources, by:
ingesting into a data structure, different tokens representative of textual phrases describing topical content specified as relevant by an end user;
generating a primary dense vector representation of the data structure;
establishing different communicative connections to respectively different heterogeneous content sources through respectively different application programming interfaces (APIs) and retrieving textual content from each of the content sources through the different communicative connections;
generating secondary dense vector representations for portions of the retrieved textual content and comparing each of the secondary dense vector representations to the primary dense vector representation in order to detect a threshold similarity;
assembling a prompt to a large language model (LLM) with the data structure and portions of the textual content corresponding to ones of the secondary dense vector representations which are determined to be threshold similar, and submitting the prompt to the LLM; and,
retrieving from the LLM in response to the prompt a set of references to the retrieved textual content and transmitting the set of references to the end user.

12. The device of claim 11, wherein the instructions are further enabled to perform:
assigning a relevancy score to each of the references in the set; and,
low rank adaptation fine tuning the LLM according to the assigned relevancy score of each of the references in the set.

13. The device of claim 11, wherein the instructions are further enabled to perform:
assigning a relevancy score to different tokens in the data structure; and,
low rank adaptation fine tuning the LLM according to the assigned relevancy score of the different tokens.

14. The device of claim 11, wherein the instructions are further enabled to perform: retrieving from the LLM in response to the prompt in addition to the set of references, justification text justifying a selection of each of the references included in the set; and,
including portions of the justification text in the transmission in connection with corresponding ones of the references in the set.

15. The device of claim 11, wherein the instructions are further enabled to perform: including different values for the similarity in the transmission in connection with corresponding ones of the references in the set.
